(19) United States
(12) Patent Application Publication
(10) Pub. No.: US 2008/0295685 A1
(43) Pub. Date: Dec. 4, 2008

(54) Air Filter Cartridge and Method for Identifying Characteristics of an Air Filter Cartridge

(75) Inventors: Matthias Uhland, Ulm (DE); Eduard Hilberer, Hockenheim (DE); Klaus Krockenberger, Stein (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahreuge GmbH, Muenchen (DE)

(21) Appl. No.: 12/106,636

(22) Filed: Apr. 21, 2008

Related U.S. Application Data
(63) Continuation of application No. PCT/EP2006/009092, filed on Sep. 19, 2006.

(30) Foreign Application Priority Data
Oct. 20, 2005 (DE) 10 2005 050 635.6

(51) Int. Cl. B01D 27/00; B01D 46/42

(52) U.S. Cl. 95/25; 96/417

(57) ABSTRACT

An air filter cartridge is mounted in an air purification device of a commercial vehicle. The air filter cartridge includes an identification device, the information of which can be recorded by a recording device. The method detects the characteristics of an air filter cartridge for use with the air purification device.

### CROSS-REFERENCE TO RELATED APPLICATIONS

This application is a continuation of PCT International Application No. PCT/EP2006/009092, filed on Sep. 19, 2006, which claims priority under 35 U.S.C. § 119 to German Application No. 10 2005 050 635.6, filed Oct. 20, 2005, the entire disclosures of which are expressly incorporated by reference herein.

### BACKGROUND AND SUMMARY OF THE INVENTION

The invention relates to an air filter cartridge, which is mounted on an air purification device of a commercial vehicle.

The invention also relates to a method for detecting properties or characteristics of an air filter cartridge mounted on an air purification device of a commercial vehicle.

Numerous functions in commercial vehicles are based on the use of compressed air. Examples of compressed air consumers are pneumatic brake systems, air suspension systems and axle lifting devices. The compressed air is made available to these and to other consumers via an air purification device. Modern air purification devices operate on the basis of an electronic controller, and for the operation of the pneumatic system of the commercial vehicle, they contain important components, for example a pressure regulator, a multi-circuit protection valve, and an air filter cartridge. The air filter cartridge serves, in particular, to clean and purify the air supplied by the compressor.

The air filter cartridges are usually screwed on to the valve housing of the air purification device, the connection dimensions being defined as part of measures for standardizing and optimizing the connection properties. Since the connecting thread is optimized in terms of strength, its thread type and thread diameter cannot be changed in any desired way.

Despite these identical connection dimensions, air filter cartridges may be very different, in particular, having different modes of operation and/or different drying or purification capacities. In view of the identical or standard connections, this can be problematic since when the filter cartridge is replaced in the course of a repair or a service, it is always possible for cartridges to be screwed on which have properties that are not compatible, or only compatible to an unsatisfactory degree, with the air purification system of the utility vehicle. An incorrect mode of operation considerably reduces the operating power of the system. In the worst case, this will then only become apparent when damage occurs.

In addition to the discussed problems, there is also a need to change an air filter cartridge at the correct time, that is to say not too late, in order to maintain the functional capability of the compressed air supply, but also not too early in order to avoid disposing of an air filter cartridge which is actually still functionally capable.

The invention is based on the object of ensuring that air filter cartridges are replaced correctly and at the optimum time.

This object is achieved by providing an air filter cartridge for mounting on an air purification device of a commercial vehicle, wherein the air filter cartridge has an identifier, whose information content can be sensed by a sensing device. The method detects the characteristics of the mounted air filter cartridge.

Advantageous embodiments of the invention are described and claimed herein.

According to the invention, the air filter cartridge has an identification device whose information content can be sensed by a sensing device. By virtue of the sensing of information, which is assigned to the air filter cartridge, monitoring is possible in order to ensure that an incorrect air filter cartridge is not screwed on when the air filter cartridge is replaced, and also to ensure that an air filter cartridge is replaced at the correct time.

There is usefully provision for the identification device to include a transponder, wherein the transponder contains a code which can be read out by use of an electromagnetic sensing device. Such a transponder is generally available and is useful to provide the air filter cartridge with the required properties.

It is likewise possible to provide that the identification device includes a bar code, which can be read out by way of an optical sensing device. This is also a generally available technology for automatically sensing object-specific data and evaluating it in a suitable way.

It is particularly preferred for the sensing device to be integrated into a control unit of the air purification device. Modern air purification systems have an electronic control unit, which controls numerous basic functions of the compressed air supply. Such a control unit has, inter alia, a microcontroller, memory devices, and a data interface so that on this basis it is suitable for evaluating the data which is sensed by the sensing device and making it available for any desired further processing.

According to one particularly preferred embodiment of the present invention, there is provision for the identification device to contain information about the type of air filter cartridge. The information about the type makes it possible to ensure that a filter cartridge can be replaced only with a filter cartridge of the same type.

According to a further preferred embodiment, there is provision for the identification device to individually characterize the air filter cartridge. This individual information can be employed particularly beneficially to ensure the suitable service intervals.

According to the inventive method, the air filter cartridge has an identification device whose information content is sensed by a sensing device. On this basis, the advantages and particular features of the air filter cartridge according to the invention are implemented within the scope of the method.

In this sense, it is possible to provide for the identification device to include a transponder, wherein the transponder contains a code which is read out by way of an electromagnetic sensing device.

On this basis, the method is developed in particular in that, after the ignition of the utility vehicle has been switched on, a transmitting and receiving antenna of the sensing device sets up an electromagnetic field in the region of the transponder. The transponder emits electromagnetic radiation containing a code, prompted by the electromagnetic field. The electromagnetic radiation, which is emitted by the transponder, is sensed by the transmitting and receiving antenna of the sensing device. And, the code is compared with stored data. As a result of the comparison of the code with the stored data, it is then possible, in particular, to determine whether an air filter cartridge of the correct type is screwed on.

According to a further embodiment of the method, there is provision for the identification device to include a bar code which is read out by way of an optical sensing device.

In order to equip the air purification device with an air filter cartridge of the correct type, there is provision that the identification device contains information about the type of air filter cartridge, and that a warning signal is generated if there is a deviation from a predefined type. If such a warning signal is present, it is to be ensured that an air filter cartridge of another type is screwed on so that a warning signal is no longer issued.

In order to optimize maintenance, it is usefully provided for the identification device to individually characterize the air filter cartridge. The information, which is available on the basis of the individual characterization, is taken into account in the maintenance of the air purification system.

Other objects, advantages and novel features of the present invention will become apparent from the following detailed description when considered in conjunction with the accompanying drawings.

### BRIEF DESCRIPTION OF THE DRAWINGS

FIG. 1 shows an air purification device with an air filter cartridge and its data-transmitting connection to further components of a commercial vehicle; and

FIG. 2 shows part of an air purification device with an air filter cartridge and, in particular, the arrangement of an identification device and of a sensing device.

### DETAILED DESCRIPTION OF THE DRAWINGS

In the subsequent description of preferred embodiments of the invention, identical reference signs denote identical or comparable components. The invention will be described by way of example with reference to an air filter cartridge with a transponder. Of course, basically any identification device which can be read out automatically by way of a sensing device can be used within the scope of the invention.

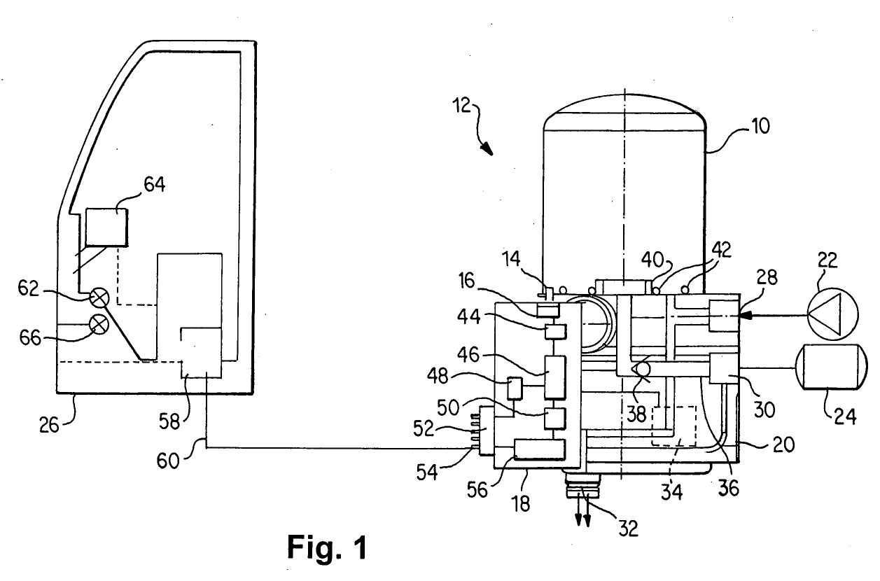

FIG. 1 shows an air purification device with an air filter cartridge and its data-transmitting connection to further components of a commercial vehicle. The air purification device 12 includes, as essential components, a filter cartridge 10 having a transponder 14, a valve housing 20 with pneumatic, electrical and electropneumatic components arranged therein, and a control unit 18, which is arranged on the valve housing. In the vicinity of the air purification device 12, there is a compressor 22 for making available compressed air, a reservoir vessel 24 (illustrated, by way of example for a plurality of reservoir vessels) and a driver's cab 26.

The region of the valve housing 20 includes a feed line connection 28, a consumer connection 30, a venting device 32 and a relief valve 34. Ducts are provided through which compressed air can flow, and in this context a nonreturn valve 38 is provided in the duct 36. The nonreturn valve 38 permits flow from the filter cartridge 10 to the consumer connection 30 and prevents flow in the opposite direction.

The filter cartridge 10 is connected to the valve housing 20 via a connecting thread 40. This connection is sealed by use of seals 42.

The control unit 18 contains a sensing device 16 with a transmitting and receiving antenna, a decoder 44, which is connected thereto, a microcontroller 46, which is connected to the decoder 44, an interface 48 for serial communication, a plug 52 which has, inter alia, a terminal 54 for serial communication, a read-and-write memory 50, and a power unit 56. These and other components are used for controlling the compressed air supply and for the inventive detection of properties or characteristics of the air filter cartridge 10.

The described system operates as follows. After the ignition has been switched on, the transmitting and receiving antenna of the sensing device 16 generates electrical radiation with a specific frequency in the region of the transponder 14 which has been bonded on to the filter cartridge 10 or is caulked therein. The electromagnetic waves are modulated by the transponder 14 in accordance with a stored code and reflected. For this purpose, it is possible to use a passive transponder 14 which does not require a separate power supply. The sensing device transmits the received signals to the decoder 44. Subsequently, plausibility checking is performed by comparing signals decoded by the decoder 44 with data stored in the memory 46. The means which are necessary for these operations can be implemented in the microcontroller 46. If the decoded data does not correspond to the stored data, the control unit transmits corresponding information to an on-board computer 58, arranged in the driver's cab 26, via the interface 58 and the plug 52 or its terminal for serial communication 54. This transmission can take place via the CAN bus 60 of the commercial vehicle. The on-board computer 58 can then actuate a warning lamp 62 and display corresponding information on an information and diagnostic display 64. The information and diagnostic display is preferably equipped with a control unit. The warning lamp 62, which indicates a faulty air filter cartridge 10, can be arranged in the region of other displays 66 within the driver's cab.

As described above, the type of filter cartridge 10 can be checked whenever the ignition of the vehicle is switched on. However, it is also contemplated for other events to initiate a check, for example whenever the filter cartridge 10 is screwed on or when a momentary contact switch is activated.

It is explained that the memory 50 stores data with which the decoded code of the transponder 14 is compared. It is possible for this data to be stored in an unchangeable fashion in the memory 50. Likewise it is contemplated for this data to be changed by external intervention, for example within the scope of a maintenance process. A further possible way of changing the data may specifically be provided by transferring information present in the transponder into the memory. This may be useful if a different type of filter cartridge 10 is to be used for a specific air purification device. It is then sufficient to use the new type of filter cartridge 10 and, for example by activating a momentary contact switch which is not readily accessible, to cause data which corresponds to the information in the transponder 14 of the new filter cartridge 10 to be stored in the memory.

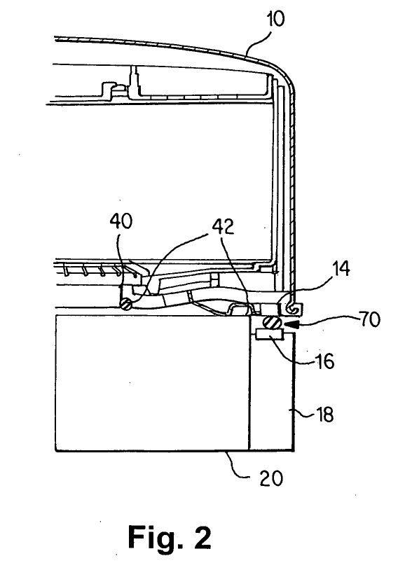

FIG. 2 shows part of an air purification device with air filter cartridge and, in particular, the arrangement of the identification device and the sensing device. It is apparent that the transponder 14 and the transmitting and receiving antenna of the sensing device 16 are arranged to be adjacent to one another in order to implement a shortest possible radio link 70. On this basis, low transmission powers are sufficient, which may be advantageous with respect to the further electronic components in the control unit 18.

In addition to the described monitoring of the correct type of filter cartridge, the illustrated system also serves to optimize the maintenance. For this purpose, the control unit 18 contains data such as the real time, the date, and the kilometer reading of the utility vehicle. Further data may be present, such as the maximum distance which can still be traveled or the maximum operating time which is still possible. In the case of a visit to a workshop, it is also possible to store a service reset. If the air filter cartridge 10 has been changed, the control unit 18 transmits a reset request in order to reset the data in the on-board computer 58.

The signals which are exchanged between the individual components include, in particular, a service reset S01, a reset request S02, information signals about the next filter cartridge change or the maximum kilometer reading S03 which is still possible, and signals relating to the real time, date, kilometer reading, etc. S04. The signals S01 and S04 are transferred from the on-board computer 58 to the control unit 18, while the signals S02 and S03 are transferred from the control unit 18 to the on-board computer. A further signal S05, specifically the engine speed, is made available to the control unit 18 by an engine management unit. A signal S06 can be transferred from the on-board computer 58 to the unit having the display 64 and warning lamp 62 if there is an incorrect filter cartridge. On the basis of this exchange of signals, the control unit 18 carries out the following functions:
Estimation of the wear of the filter cartridge taking into account information from the engine management unit and the operating time.
Determination of the maximum operating time of the filter which is still possible.
Checking whether the filter has already been changed.
Checking whether a suitable filter cartridge has been inserted.
Logic combination of the data with the kilometer information and the real time information.
Adaptation of the regeneration behavior.

The on-board computer 58 manages essentially the following information:
Driver information.
Warnings.
Management of servicing.
Information relating to the normal service interval or the reduced service interval.

The information relating to the normal or reduced service interval results from the adaptation of the regeneration behavior, specifically by virtue of the fact that when the efficiency of the filter cartridge is reduced the quantity of regeneration air is increased.

If a service is recommended, the on-board computer combines this with further service recommendations, which have been issued by other control units, and transmits an advance warning or a warning to the display 64. Corresponding information is output.

When a servicing operation is concluded, the corresponding data of the units which have been serviced is reset by way of external diagnostics. If the filter cartridge has been changed, the control unit 18 of the air dryer recognizes this on the basis of the individual information which is stored in the transponder or this information is made available to the control unit in some other way.

If a filter of the wrong design has been screwed on during the service, this is also recognized by the control unit 18 and a fault message is transmitted to the on-board computer 58. This fault message is documented within the scope of the external diagnostics.

The features of the invention which are disclosed in the present description, in the drawings and in the claims can implement the invention, either individually or in any desired combination.

Table of Reference Numerals
10 filter cartridge
12 air purification device
14 identification means
16 sensing device
18 control unit
20 valve housing
22 compressor
24 reservoir vessel
26 driver's cab
28 feed line connection
30 consumer connection
32 venting means
34 relief valve
36 duct
38 nonreturn valve
40 connecting thread
42 seals
44 decoder
46 microcontroller
48 interface
50 read-and-write memory
52 plug
54 terminal
56 power unit
58 on-board computer
60 CAN bus
62 warning lamp
64 display
66 further displays
70 radio link

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for detecting characteristics of an air filter cartridge utilizing a transponder and sensing device, the air filter cartridge being mounted on an air purification device of a commercial vehicle, the method comprising the acts of:
switching-on an ignition of the commercial vehicle;
generating an electromagnetic field, via a transmitting and receiving antenna of the sensing device, in a region of a transponder arranged on the air filter cartridge, after the ignition is switched on;
emitting electromagnetic radiation, containing a code, from the transponder upon being prompted by the generated electromagnetic field;
sensing the emitted electromagnetic radiation containing the code by the transmitting and receiving antenna of the sensing device;
comparing the code with stored data; and
activating a momentary contact switch, which switch is not readily accessible, to cause information present in the transponder arranged on the air filter cartridge to be transferred into a memory of the sensing device.

2. The method according to claim 1, wherein the transponder contains information about a type of the air filter cartridge, and further wherein a warning signal is generated if the type is determined to deviate from a predefined type upon comparing the code with the stored data.

3. The method according to claim 1, wherein the code individually characterizes the air filter cartridge, and further wherein information available based on the individual characterization is utilized in performing maintenance of the air purification device.

4. A component of an air purification device for a commercial vehicle, comprising:
an air filter cartridge mountable on the air purification device of the commercial vehicle; and
an identification device arranged on the air filter cartridge, information content contained in the identification device being capable of being sensed by a sensing device.

5. The component according to claim 4, wherein the identification device comprises a transponder, the transponder containing a code which is read-out via an electromagnetic sensing device.

6. The component according to claim 4, wherein the identification device comprises a bar code, the bar code being read-out via an optical sensing device.

7. The component according to claim 4, wherein the sensing device is integrated into a control unit of the air purification device.

8. The component according to claim 4, wherein the identification device contains type information about the air filter cartridge.

9. The component according to claim 5, wherein the identification device contains type information about the air filter cartridge.

10. The component according to claim 6, wherein the identification device contains type information about the air filter cartridge.

11. The component according to claim 4, wherein the identification device individually characterizes the air filter cartridge.

12. The component according to claim 5, wherein the identification device individually characterizes the air filter cartridge.

13. The component according to claim 6, wherein the identification device individually characterizes the air filter cartridge.
